(19) United States
(12) Patent Application Publication
(10) Pub. No.: US 2011/0280607 A1
(43) Pub. Date: Nov. 17, 2011

(54) FIXING DEVICE AND IMAGE FORMING APPARATUS PROVIDED THEREWITH

(75) Inventor: Hideaki Tanaka, Tokyo (JP)

(73) Assignee: KONICA MINOLTA BUSINESS TECHNOLOGIES, INC., Tokyo (JP)

(21) Appl. No.: 13/104,609

(22) Filed: May 10, 2011

(30) Foreign Application Priority Data
May 12, 2010 (JP) 2010-109971

(51) Int. Cl. G03G 15/20; G03G 13/20

(52) U.S. Cl. 399/67

(57) ABSTRACT

A fixing device by fixing an image on a recording material at a nip portion, includes: an air blower which blows air sent by a fan on the neighborhood of an exit of the nip portion; a pressure contact and separation switching section which switches from a separated state in which a pressure member is separated from a fixing member to a pressure contact state in which the pressure member is in contact with the heating member at a moment that is earlier by a predetermined period of time than a time when a leading edge of the recording material arrives at the nip portion; and a controller which controls the fan to start its rotation within a first time period between a time when a changeover from the separated state to the pressure contact state is started and a time when the leading edge of the recording material arrives at the nip portion.

This application is based on Japanese Patent Application No. 2010-109971 filed on May 12, 2010, which is incorporated hereinto by reference.

### BACKGROUND OF THE INVENTION

The present invention relates to a fixing device wherein a toner image on a recording material is fixed at a nip portion that is composed of a fixing member and of a pressure member, and then, the recording material is separated from the fixing member when air is caused to blow against an exit side of the nip portion.

In an image forming apparatus of an electrophotographic method such as a copying machine, a printer, a facsimile machine and a multifunctional peripheral equipped with various functions of the aforesaid items, a latent image corresponding to a document is formed on a photoconductor, then, the latent image is given toner to be visualized, and this visualized toner image is transferred onto a recording sheet, and after this, the toner image transferred onto the recording sheet is fixed to be ejected.

As a fixing device to fix toner images, there is available a fixing device of a heat roller fixing method that heats a recording sheet onto which a toner image has been transferred and applies pressure to it, on a nip portion that is composed of a fixing roller housing therein a halogen heater and of a pressure roller that applies pressure to the fixing roller, while interposing and conveying the recording sheet onto which the toner image has been transferred. The fixing device of this kind is used widely, because of its simplicity in structure.

Further, there is available a fixing device of a belt fixing method, wherein a fixing belt of an endless type is trained about a heat roller housing therein a halogen heater and about a fixing roller, then, a pressure roller that applies pressure to the fixing roller through the fixing belt is provided, and the recording sheet onto which the toner image has been transferred is heated and is applied with pressure, while it is being heated and is applied with pressure while the recording sheet onto which a toner image has been transferred is interposed and conveyed, at a nip portion that is formed by the fixing belt and the pressure roller.

In this case, toner of a toner image on the recording sheet is heated when it passes through a nip portion. Therefore, toner has adhesive power, and the recording sheet having passed through the nip portion sticks to the surface of the fixing roller and of the fixing belt to keep sticking without being separated, resulting in a fear to cause jamming. As a recording sheet, in particular, when a sheet having a small basis weight (a thin sheet) is used, and besides, when coated printing paper having a small basis weight is used, separation ability is lowered more.

On the other hand, when a fixing roller is made to be large for securing a nip width with a sufficient length under a tendency of advanced speeding up of an image forming apparatus, separation ability is lowered more, because curvature of the roller at a way out of the fixing nip portion becomes small.

For the purpose of easy separation of a recording sheet from a fixing member, there are taken various measures such as using heat-resistant resins having high separability on a surface layer of the fixing member, coating releasing agents such as silicon oil, and causing wax that is melted by heat to function as releasing agents to be included in toner. However, image forming on the aforesaid coated paper and superposing of plural colors forming a color image result in an increase of toner amount, which causes an increase of toner amount that increases toner adhesion force, thus, an important factor for lowering separation ability is increased, which has made a separation measure that separates a recording sheet to be indispensable.

As the separation measure, there is a method to separate a recording sheet from a fixing roller by providing a separation claw which is coated with fluorine resin having excellent separability on the sheet ejection side of the recording sheet corresponding to the nip portion.

However, there is a problem that a surface layer that is formed by fluorine resins that covers a surface of the fixing roller, is scratched, and the scratch is transferred onto an image, because a pointed end of the separation claw is in touch with the surface of the fixing roller. In the case of a color image, in particular, this problem tends to appear remarkably, because glossy images are required.

For the purpose of coping with the problem of this kind, there has been developed a technology to separate a recording sheet from a fixing roller by causing air to blow against a way out side of the nip portion.

As an example of this technology, there is known an image forming apparatus wherein a fan and a nozzle are provided on the downstream side of the nip portion in the direction of rotation of the fixing roller, and air blows from a nozzle in synchronization with timing for the leading edge of the recording sheet to leave the nip portion, so that the recording sheet after fixing may not wind around the fixing roller (see Japanese Patent Application Publication No. 2005-258035).

Further, there is known a fixing device wherein air blows for separating a recording sheet in the same way as in Japanese Patent Application Publication No. 2005-258035, wherein an operation of a fan is started, interlocking with an operation of a separation-contact clutch of the second order transfer roller (see Japanese Patent Application Publication No. 2002-311740).

Concerning the operation of the fan, it is synchronized with the timing when a leading edge of a recording sheet leaves a nip portion in Japanese Patent Application Publication No. 2005-258035, and it is interlocked with an operation of the separation-contact clutch of the second order transfer roller in Japanese Patent Application Publication No. 2002-311740).

A fan starts its rotation when a switch connected to the fan is turned on, and a speed of the rotation is increased gradually, to take a predetermined period of time to arrive at its maximum speed. Therefore, in Japanese Patent Application Publication No. 2005-258035, when the leading edge of the recording sheet arrives at the nip portion, the rotation speed of the fan is still low and wind speed is insufficient, which hardly contributes to separation of the recording sheet. On the other hand, if the fan rotation is started early like an occasion of Japanese Patent Application Publication No. 2002-311740, the rotation of the fan is at its maximum speed when the leading edge of the recording sheet arrives at the nip portion, which makes the separation of the recording sheet to be possible.

In the fixing device of a belt type, when a pressure roller makes pressure contact with a fixing belt in the case of fixing, a fixing roller is pressed to be deformed elastically through the fixing belt, to form the nip portion. However, if the pressure roller keeps its pressure contact constantly as stated above, there is a fear that a permanent distortion is generated on the fixing roller to deteriorate fixing ability. In addition, durability is also lowered for both the pressure roller and the fixing roller. With a background of the foregoing, there is known a fixing device that is equipped with a pressure contact and separation switching section wherein the pressure roller is separated by the use of a motor and a cam during non-fixing time. In the fixing device of this kind, the pressure contact and separation switching section operates automatically before the leading edge of the recording sheet arrives at the nip portion, to switch the pressure roller to the state of pressure contact from the state of separation.

However, when the fan is started early for the reasons that air blows against a nip portion for separating the recording sheet, and a predetermined period of time is taken for the fan to arrive at its maximum speed in the fixing device equipped with a pressure contact and separation switching section, and when the pressure roller at that time is still in its separated state, the following problems are generated.

Namely, when air that is sent by rotation of a fan is blown on the neighborhood of a way out of the nip portion, if the pressure roller is in the state of separation, the air blows through a space between the pressure roller and the fixing belt to flow to the upstream side of the fixing device. Since the fixing belt is heated up to 170° to 210° in this case, for example, the air that blows through the space between the pressure roller and the fixing belt is heated up to the high temperature. Since an intermediate transfer belt and a transfer device are arranged at the upstream side of the fixing device, if the air at high temperature touches them, toner positioned at that place is melted to cause image defects.

### SUMMARY OF THE INVENTION

The present invention is one invented in view of the problems stated above, and its objectives are to suggest a fixing device wherein the aforesaid problems are not generated even when both of the air blowing measure and the pressure contact and separation switching section are provided for separation of the recording sheet, and to suggest an image forming apparatus that is equipped with the aforesaid fixing device.

Incidentally, in Japanese Patent Application Publication Nos. 2005-258035 and 2002-311740, there is no description about a pressure contact and separation switching section, much less about the aforesaid problems.

The aforesaid objectives are attained by the invention described below.

1. To achieve at least one of the abovementioned objects, in a fixing device reflecting one aspect of the present invention, in which a toner image on a recording material is fixed at a nip portion that is formed by a heated fixing member and by a pressure member that applies pressure for the fixing member, the fixing device comprises: an air blower that blows air that is sent by rotation of a fan on the neighborhood of a way out (an exit) of the nip portion, a pressure contact and separation switching section that is capable of switching between the pressure contact state in which the aforesaid pressure member conducts pressure contact against the aforesaid fixing member and the separated state, and switches from the aforesaid separated state to the pressure contact state at a moment that is earlier by a predetermined period of time than a point in time when a leading edge of the recording material arrives at the nip portion, and a controller that controls so that the aforesaid fan starts its rotation within the first time period between a point in time when the aforesaid pressure contact and separation switching section starts a changeover from the aforesaid separated state to the aforesaid pressure contact state and a point in time when the leading edge of the recording material arrives at the nip portion.

2. In the fixing device described in the aforesaid Item 1, it is preferable that the aforesaid controller controls to start the rotation of the aforesaid fan so that the rotation of the fan reaches a maximum speed in the aforesaid first time period.

3. In the fixing device described in the aforesaid Item 1, it is preferable that the aforesaid controller controls to start the rotation of the aforesaid fan so that the rotation of the fan reaches a maximum speed in a second time period between a point in time when the aforesaid pressure contact and separation switching section finishes the changeover from the separated state to the pressure contact state and a point in time when the leading edge of the recording material arrives at the nip portion.

4. An image forming apparatus equipped with either one of the aforesaid Items 1 to 3.

### BRIEF DESCRIPTION OF THE DRAWINGS

FIG. 1 is a structural diagram of an image forming apparatus.

FIG. 2 is a sectional view of a fixing device.

Each of FIGS. 3A and 3B is a diagram of a pressure contact and separation switching section.

FIG. 4 is a graph showing a rotation ratio for rotation time of a fan.

FIG. 5 is a diagram showing a point in time of a start of rotation of a fan for the changeover passage from the separated state to the pressure contact state by the pressure contact and separation switching section.

FIG. 6 is a block diagram that controls a pressure contact and separation switching section and an air blower.

### DETAILED DESCRIPTION OF THE PREFERRED EMBODIMENT

An embodiment relating to the invention will be explained as follows, referring to the drawings.

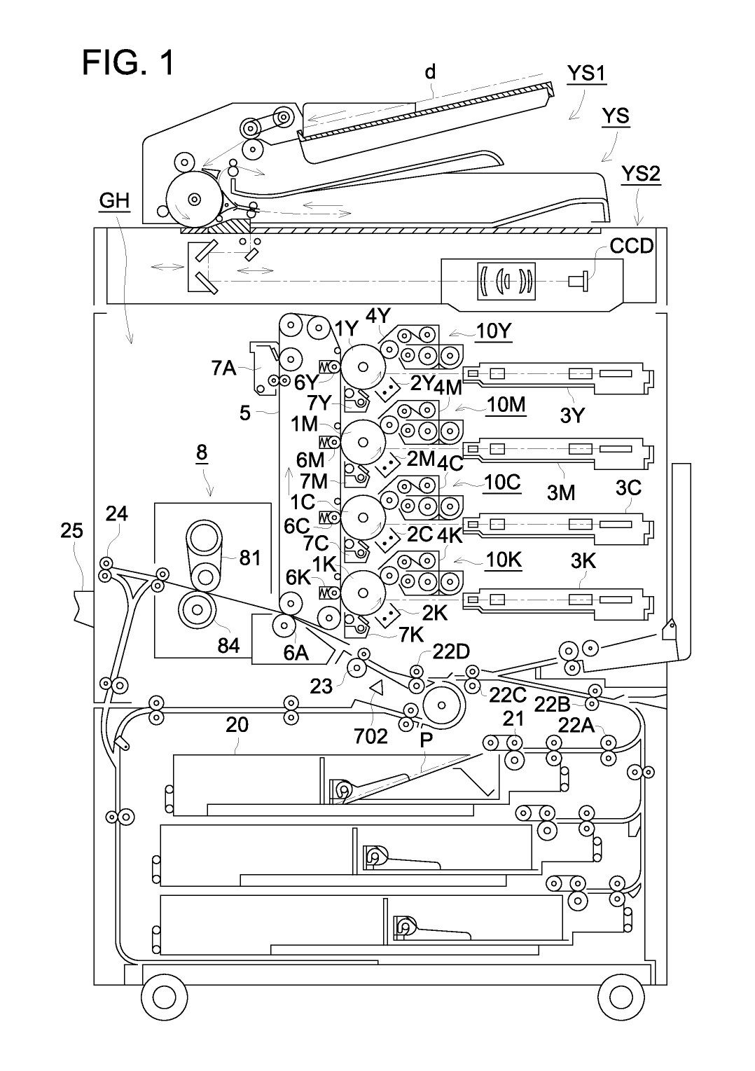

First, an example of an image forming apparatus that employs the present invention will be explained based on FIG. 1 that is a structural diagram.

The present image forming apparatus is composed of image forming apparatus main body GH and of image reading device YS.

The image forming apparatus main body GH is one called a tandem type color image forming apparatus which is composed of a plurality of image forming sections 10Y, 10M, 10C and 10K, belt-type intermediate transfer belt 5, a sheet-feed conveyance device and of fixing device 8.

On the upper part of the image forming apparatus main body GH, there is arranged image reading device YS that is composed of automatic document feeder YS1 and of document image scanning exposure device YS2. Document “d” placed on a document platen of the automatic document feeder YS1 is conveyed by a conveyance device, then, images on both sides of a document or an image on one side of the document is scanning-exposed by an optical system of the document image scanning exposure device YS2, and the image is read into line image sensor CCD.

A signal that is formed through photoelectric conversion by line image sensor CCD is subjected to analog processing, A/D conversion, shading correction and image compression processing in the image processing section, and is sent to exposure steps 3Y, 3M, 3C and 3K.

In image forming section 10Y that forms an image in a yellow (Y) color, there are arranged charging unit 2Y, exposure unit 3Y, developing unit 4Y and cleaning unit 7Y around photoconductor drum 1Y. In image forming section 10M that forms an image in a magenta (M) color, there are arranged charging unit 2M, exposure unit 3M, developing unit 4M and cleaning unit 7M around photoconductor drum 1M. In image forming section 10C that forms an image in a cyan (C) color, there are arranged charging unit 2C, exposure unit 3C, developing unit 4C and cleaning unit 7C around photoconductor drum 1C. In image forming section 10K that forms an image in a black (K) color, there are arranged charging unit 2K, exposure unit 3K, developing unit 4K and cleaning unit 7K around photoconductor drum 1K. And, a latent image forming device is composed of each of combinations respectively of charging unit 2Y and exposure unit 3Y, charging unit 2M and exposure unit 3M, charging unit 2C and exposure unit 3C, and charging unit 2K and exposure unit 3K.

Incidentally, each of developing units 4Y, 4M, 4C and 4K involves therein two component developer composed of small-particle size toner and carrier. The toner is composed of pigment or dye serving as color forming agents, wax that contributes to toner separation from fixing member after fixing and of binder resin that holds the aforesaid items.

Intermediate transfer belt 5 is trained about a plurality of rollers, and it is supported to be capable of rotating.

In fixing device 8, a toner image on recording sheet (recording material) P is heated and pressurized to be fixed at a nip portion that is formed between heated fixing belt 81 and pressure roller 83.

In this way, images each being in a respective color which are formed respectively by image forming sections 10Y, 10M, 10C and 10K are transferred onto rotating intermediate transfer belt 5 respectively by transfer units 6Y, 6M, 6C and 6K in succession (primary transfer), thus, a toner image wherein images each being in a respective color are composed is formed. Recording sheet P stored in sheet-feed cassette 20 is fed by sheet-feed device 21 and is conveyed to transfer device 6A after passing through sheet-feeding rollers 22A, 22B, 22C, 22D and registration roller 23, thereby, the color image is transferred onto recording sheet P (secondary transfer). The recording sheet P onto which the color image has been transferred is heated and pressurized at fixing device 8, and the color toner image on the recording sheet P is fixed. After that, the recording sheet P is interposed by sheet-ejection roller 24 to be placed on sheet-ejection tray 25 that is in the outside of the apparatus.

On the other hand, after the color image is transferred onto recording sheet P by transfer device 6A, intermediate transfer belt 5 from which the recording sheet P has been curvature-separated is cleaned by cleaning device 7A in terms of residual toner.

Incidentally, though the foregoing has been for an image forming apparatus that forms a color image, the foregoing may also be an image forming apparatus that forms a black and white image, and the intermediate transfer belt may either be used or be omitted.

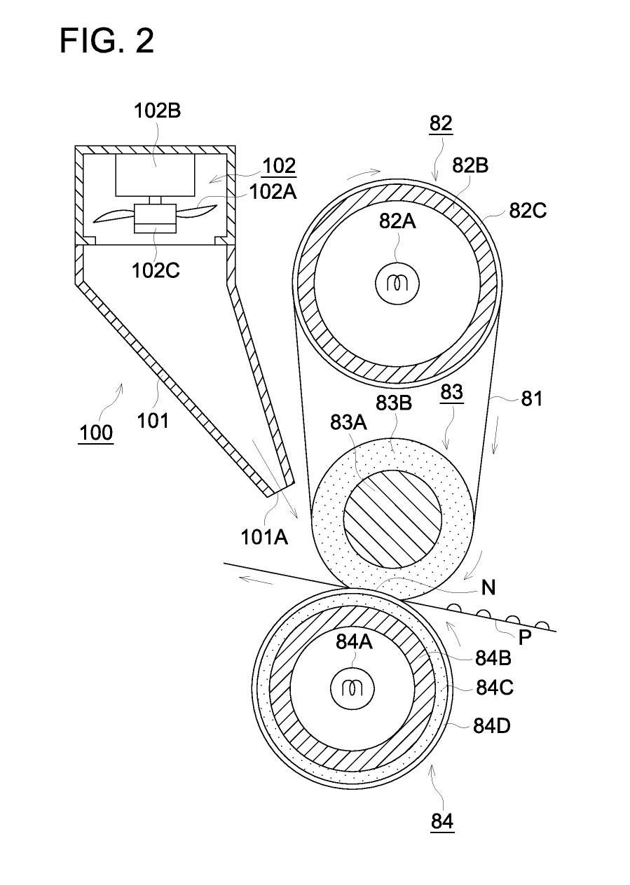

Next, the fixing device 8 will be explained as follows based on the sectional view of FIG. 2.

Fixing belt 81 (fixing member) is formed to be in an endless form, and, for example, an outer circumference surface of a 70 μm-thick substrate that is made of conductive PI (polyimide) is covered by 220 μm-thick elastic layer, and it is further covered by a 30 μm-thick tube that is made of PFA (perfluoroalkoxy) representing heat-resistant resin. Incidentally, a dimension of an inside diameter, for example, is 80 mm.

Heat roller 82 houses therein halogen heater 82A that heats fixing belt 81, and an outer circumference surface of cylindrical core metal 82B whose thickness is 3 mm that is made of aluminum, for example, is covered by a resin layer 82C that is coated by 30 μm-thick PFA. Incidentally, an outside diameter dimension, for example, is 52 mm.

Further, with respect to halogen heater 82A, it is of a type wherein distributed heat source is different in the axial direction, by providing a 930 W portion and a 600 W portion, to deal with sheets which are different in terms of a sheet width.

With respect to fixing roller 83, its solid core metal 83A made by a metal such as steel is covered by 7.5 mm-thick elastic layer 83B that is made of silicone rubber (hardness JIS-A10°) representing heat-resistant solid rubber. Incidentally, an outside diameter dimension, for example, is 40 mm. It is further possible to use fluorine-containing rubber in place of silicone rubber.

Pressure roller 84 (pressure member) houses therein halogen heater 84A for reducing temperature-rising time period immediately after power-on operation for the image output apparatus, and an outer circumferential surface of cylindrical cored tube 84B with radial thickness of 3 mm made of aluminum is covered by 2 mm-thick elastic layer 84C made of heat-resistant silicone rubber (hardness JIS-A 20°), which is further covered by resin layer 84D of 30 μm-thick PFA tube. Incidentally, an outside diameter dimension, for example, is 50 mm.

Further, the halogen heater 84A, for example, is 700 W.

And, an unillustrated urging device makes pressure roller 84 to cause fixing belt 81 to conduct pressure contact against fixing roller 83.

Incidentally, it is also possible to form resin layers 82C and 84D through a covering of a tube of PTFE (polytetrafluoroethylene) or through a coating processing.

Further, it is possible to use a heating device of any type as a heating device for heating the fixing belt 81, and for example, an eddy-current heating element employing an exciting coil can also be used. In addition, the heating device does not always need to be arranged in the heating roller 82, and it can be arranged at any location.

It may further be a fixing device on which a tension roller that presses against a fixing belt is provided.

In the aforesaid structure, when fixing roller 83 is rotated clockwise by an unillustrated driving device, fixing belt 81 and heating roller 82 are also rotated clockwise, and pressure roller 84 is rotated counterclockwise. Incidentally, the pressure roller 84 may also be driven. The heating roller 82 is heated by halogen heater 82A, and the fixing belt 81 that touches the heating roller 82 is also heated. Then, since the pressure roller 84 is urged by an unillustrated urging device toward the fixing roller 83, recording sheet P which has been fed is heated and pressurized at nip portion N between fixing belt 81 that is trained about the fixing roller 83 and the pressure roller 84, thus, a toner image on the recording sheet P is fixed.

In the fixing device 8 like that mentioned above, if the recording material P that has been fixed sticks to and winds around the fixing belt 81 after being ejected from the nip portion N, there is a fear of occurrence of jamming. Therefore, the recording material P needs to be separated surely from the fixing belt 81.

In the present fixing device 8, therefore, there is provided an air blower (also referred to as an air blasting device hereinafter) 100 that sends air to the vicinity of a way out of the nip portion N as this separation measure. The air blasting device 100 is one that discharges air sent by fan motor 102, from air nozzle 101. The air nozzle 101 is formed in a way wherein a cross-sectional area of its cross section grows smaller as the cross section approaches a pointed end of the air nozzle. And the pointed end of the air nozzle 101 is directed to be in the direction of a tangential line for fixing belt 81 that is trained about fixing roller 83. In this way, air is blown constantly against recording sheet P that has left the nip portion N, so that the recording sheet P may not stick to the fixing belt 81. Further, the air nozzle 101 is made of heat-resistant resins.

Fan motor 102 is composed of fan 102A, motor 102B that drives the fan 102A to rotate and print circuit plate 102C representing a fan controller that houses therein an electronic part that supplies electric power which is inputted from an outer power source through an unillustrated switch by conducting with motor 1028, to motor 102B, and controls motor 1028.

Incidentally, the motor 1028 is a DC motor. The fan 102A may also be an axial flow fan, a sirocco fan, a cross flow fan or a blower. And though fan motor 102 at rated voltage 24V and at static pressure 125 Pa is used, what is essential is that the wind pressure and the air flow are sufficient for separating recording sheet P from fixing belt 81.

Further, in the fixing device 8, a pressure contact and separation switching section 110 that causes pressure roller 84 to be separated in the course of non-fixing period, and causes pressure roller 84 to conduct pressure contact in the course of fixing period is provided for preventing that permanent set is caused on fixing roller 83 and durability performances of fixing roller 83 and pressure-roller 84 are lowered by continuous pressure contact of pressure roller 84 against fixing roller 83.

An example of this pressure contact and separation switching section 110 will be explained by referring to FIGS. 3A-3B. FIG. 3A shows a diagram wherein pressure roller 84 is caused to conduct pressure contact in the case of fixing, and FIG. 3B shows a diagram wherein the pressure roller 84 is separated in the course of non-fixing period.

In FIG. 3A, switching member 111 is supported by supporting axis 112 to be capable of rotating around the supporting axis 112. End portion of 111A of the switching member 111 is pressed by compression spring 113 and the switching member 111 is urged clockwise. Shaft 84E provided on the end portion in the axial direction of pressure roller 84 is engaged with hole 111B provided on the switching member 111. Therefore, when the switching member 111 swings, the pressure roller 84 is moved.

Further, there is provided cam 115 that is rotated by an unillustrated motor, and the cam 115 is capable of touching cam follower 111C that is erected vertically on a page at the lower part of the switching member 111 on the drawing.

In the aforesaid structure, when separating the pressure roller 84 from fixing roller 83, the cam 115 is rotated counterclockwise from the state of pressure contact shown in FIG. 3A. Owing to this, the cam 115 presses the cam follower 111C of the switching member 111 as shown in FIG. 3B, thus, the switching member 111 is rotated counterclockwise against urging force of the compression spring 113. Therefore, the pressure roller 84 is separated from the fixing roller 83.

When conducting pressure contact of pressure roller 84 against the fixing roller 83 on the contrary, the cam 115 is rotated clockwise from the state of separation shown in FIG. 3B. Owing to this, the earn 115 is separated from the cam follower 111C of switching member 111, and the switching member 111 is rotated clockwise by urging force of the compression spring 113. Therefore, pressure contact of the pressure roller 84 is conducted against the fixing roller 83.

In the fixing device that is equipped with an air blasting device 100 and a pressure contact and separation switching section 110 as in the foregoing, when air is blown against nip portion N under the condition that pressure roller 84 is separated, the air blows through a space between the pressure roller 84 and the fixing belt 81 to flow to the upstream side of the fixing device 8. Since the fixing belt 81 is heated up to 170° to 210° in this case, air that blows through the space between the pressure roller 84 and the fixing belt 81 is heated up to the high temperature. Since intermediate transfer belt 5 and transfer device 6A are arranged at the upstream side of the fixing device 8 as shown in FIG. 1, if the air at high temperature touches the aforesaid members, toner positioned at that place is melted to cause a fear of occurrence of image defects.

On the other hand, with respect to the pressure contact and separation switching section 110, the state of separation is not switched to the state of pressure contact in a moment, but it takes a predetermined period of time. Further, when a switch of fan 102A is turned on, the fan 102A takes a predetermined period of time to arrive at its highest speed from the start of its rotation. Accordingly, it is presumed that an amount of air that flows to the upstream side of the fixing device 8 after blowing through the space between the pressure roller 84 and the fixing belt 81 varies depending also on the state of these transitional periods, resulting in a difference of influence of temperatures for the members positioned at the upstream side of the fixing device 8.

Further, it is presumed that separating power may vary depending on timing to start rotation of fan 102A, because the fan 102A takes a certain period of tune to arrive its highest speed from the start of its rotation.

It is further presumed that a temperature of the nip portion immediately after an air blast is lowered temporarily, and image defects are generated in the case of continuous sheet feeding.

Since experiments to obtain optimum conditions by taking these uncertain elements into consideration were carried out, the experiments will be explained below.

First, common conditions for all experiments are as follows.

Apparatus used for experiments: An image forming apparatus shown in FIG. 1 that is equipped with a fixing device shown in FIG. 2 having each of pressure contact and separation switching sections shown in FIGS. 3A-3B.

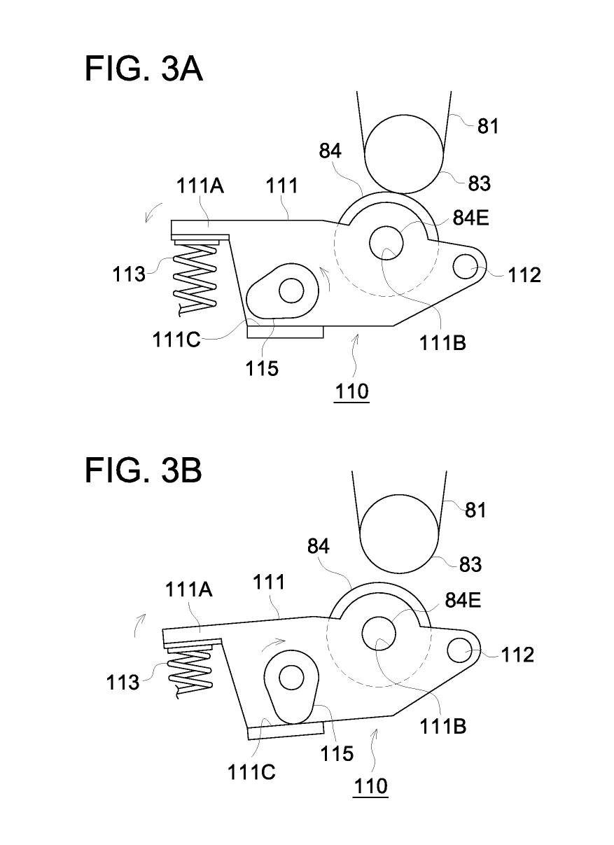

Recording sheet size: A3, A4 lengthwise and A5 lengthwise
Recording sheet basis weight: 100-300 g/m²
Environmental temperature for experiment: 20° C.
Exhaust port size of air nozzle: 2.2 mm×305 mm
Wind velocity from air nozzle: 17-18 m/s
Position of spraying from air nozzle: Position of 20 mm to downstream side from a way out of nip portion on fixing belt trained about fixing roller
Rotation ratio for rotation time period of fan: Shown in graph of FIG. 4

Time of switching from separation state to pressure contact state by pressure contact and separation switching section: approx. 1 second

(1) Certifying Experiment for Temperature Rise on Upstream Side

A. Experiment Conditions

Image pattern: Corresponding to 5% of printing rate
Temperature measurement place: Image forming sections 10Y, 10M, 10C and 10K and transfer device 6A
Method of measuring temperature: Thermocouple
Primary factor for experiments: A point of time for start of rotation of fan

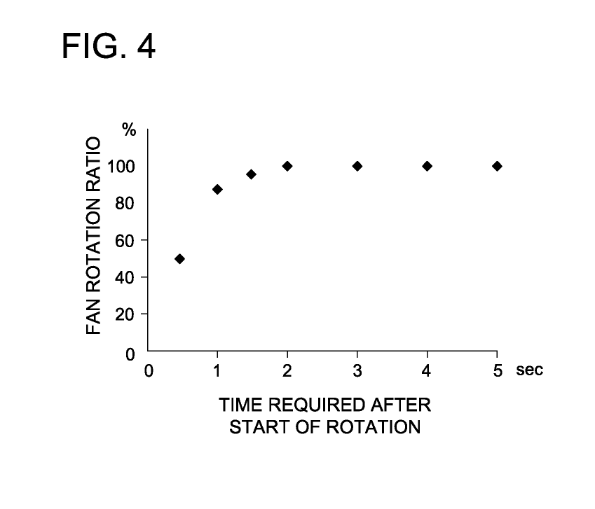

Incidentally, FIG. 5 shows points of time for start of rotation of fan A-C for the passage of switching from the state of separation to the state of pressure contact by the pressure contact and separation switching section.

B. Results of Experiments

Table 1 shows results of the experiments.

TABLE 1

| | | Point of time | |
|---|---|---|---|
| Pressure contact and | | for start | State of |
| separation switching | State of | pressure | pressure |
| section | separation | contact | contact |
| Symbol in FIG. 5 | A | B | C |
| Image forming section | 5° C. or more | Less than 1° C. | No change |
| Transfer device | 10° C. or more | Less than 1° C. | No change |
| Judgment | D | E | F |

Incidentally, rising temperatures for image forming sections 10Y, 10M, 10C and 10K as well as transfer section 6A before the sheet feeding were used for judgment, and F shows “No change”, E shows rising slightly (within 3° C.) and D shows rising greatly (more than 3° C.).

C. Consideration

In the state of separation before conducting pressure contact by the pressure contact and separation switching section, temperature rise of the members positioned at the upstream side of the fixing device are great, and these members are influenced. On the other hand, if an air blast by a fan is started in the state of pressure contact wherein pressure contact by the pressure contact and separation switching section has been completed, temperature rise of the member positioned at the upstream side of the fixing device is not caused. When the air blast by a fan is started at the point of time when the pressure roller is started by the pressure contact and separation switching section which is in an intermediate state, an influence on temperature rise of the member positioned at the upstream side of the fixing device is small even when the air blows through a space between the pressure roller and the fixing belt because an air speed at the beginning is low, while, when the wind velocity is increased, an influence on the temperature rise is small in the same way, because a clearance is decreased to cause air to be difficult to blow through.

(2) Separation Performance Confirmation Experiment.

A: Experiment Conditions

Image pattern: Printing rate 100%
Number of times for sheet feeding: 10 times
Primary factors for experiments: Point of time for start of rotation of fan.

B: Results of Experiments as Shown in Table 2 Below.

TABLE 2

| | | | | Passing through |
|---|---|---|---|---|
| | Passing through | Passing through | Passing through | nip portion |
| Time to start | nip portion | nip portion | nip portion | Immediately |
| rotation of fan | Before 5 seconds | Before 3 seconds | Before 1 second | before |
| Amount of fan | 100% | 100% | approx. 80% | 50% or less |
| rotation | | | | |
| Rate of jam | 0% | 0% | 10% | 40% |
| occurrence | | | | |

C: Consideration

When a rotation of the fan is started one second before, or immediately before the moment when a leading edge of the recording sheet passes through the nip portion, air blast at a sufficient wind velocity is impossible, because the fan takes about 2 seconds to arrive at its highest speed, thus, the recording sheet cannot be separated, resulting in occasional occurrence of jamming. Therefore, it is desirable that a rotation of the fan is started earlier than usual so that the fan may arrive at its highest speed when the leading edge of the recording sheet arrives at the nip portion.

(3) Experiments to Confirm Temperature Decline of Fixing Belt

A: Experiment Conditions

Image pattern: Corresponding to 5% of printing rate
Temperature measurement place: Three places including the center in the axial direction of fixing belt and two places at both ends at 100 mm from the center respectively
Method of measuring temperature: Thermocouple
Sheet feeding: Continuous 200 sheets
Primary factor for experiments: A point of time for start of rotation of fan

B: Results of Experiments as Shown in Table 3 Below.

TABLE 3

| | | | Passing through |
|---|---|---|---|
| Time to start | Passing through | Passing through | nip portion |
| rotation of | nip portion | nip portion | Immediately |
| fan | Before 5 seconds | Before 3 seconds | before |
| Temperature | 12° C. | 14° C. | 16° C. |
| decline value | | | |
| Judgment of | No occurrence | slight | little |
| image failure | | | |

Incidentally, a temperature decline value is the lowest decline value in each of three measuring positions.

C: Consideration

For reducing the temperature decline in the case of continuous sheet feeding, it is desirable to start a rotation of the fan earlier than the moment when the leading edge of the recording sheet passes through the nip portion.

Incidentally, when the temperature decline value is great, image failures such as damaged gloss and damaged tint are generated, and low temperature offset wherein toner slides down under insufficient fixing is caused, and these phenomena become to be remarkable when a temperature decline value becomes to be 20° C. or more.

Summarization of the aforesaid experiments is as follows.

With respect to the start of an rotation of the fan, it is desirable to start rotation of the fan in the first time period (see FIG. 5) between the point of time when switching from the state of pressure contact to the state of separation by at least the pressure contact and separation switching section is started and the point of time when the leading edge of the recording sheet is fed to the nip portion.

Owing to this, temperature rise hardly occurs on the member positioned at the upstream side of the fixing device. Therefore, image failures caused by temperature rise on the member positioned at the upstream side are not generated.

Further, it is preferable to start a rotation of the fan, earlier than usual so that the rotation of the fan may arrive at its highest speed or the speed close to the highest speed at the point of time when the leading edge of the recording sheet is fed to the nip portion in the first time period.

Owing to this, it is possible to blow the air of sufficient wind velocity to a way out of the nip portion. Therefore, it is possible to eliminate occurrence of jam caused by separation failure, and to make temperature decline in the case of continuous sheet feeding to be small.

In addition, in the second time period between the point in time when the pressure contact and separation switching section completes switching from the state of separation to the state of pressure contact and the point in time when the leading edge of the recording sheet is fed to the nip portion (see FIG. 5), it is more preferable that a rotation of a fan is started earlier than usual so that a rotation of a fan may arrive at the highest speed, or at the speed that is close to the highest speed at the point in time when the leading edge of the recording sheet is fed to the nip portion.

Owing to this, it is quite free from occurrence of image failures which are caused by temperature rise of a member positioned at the upstream side of the fixing device, and jamming caused by separation failure is not caused, and temperature decline in the case of continuous sheet feeding can be made small.

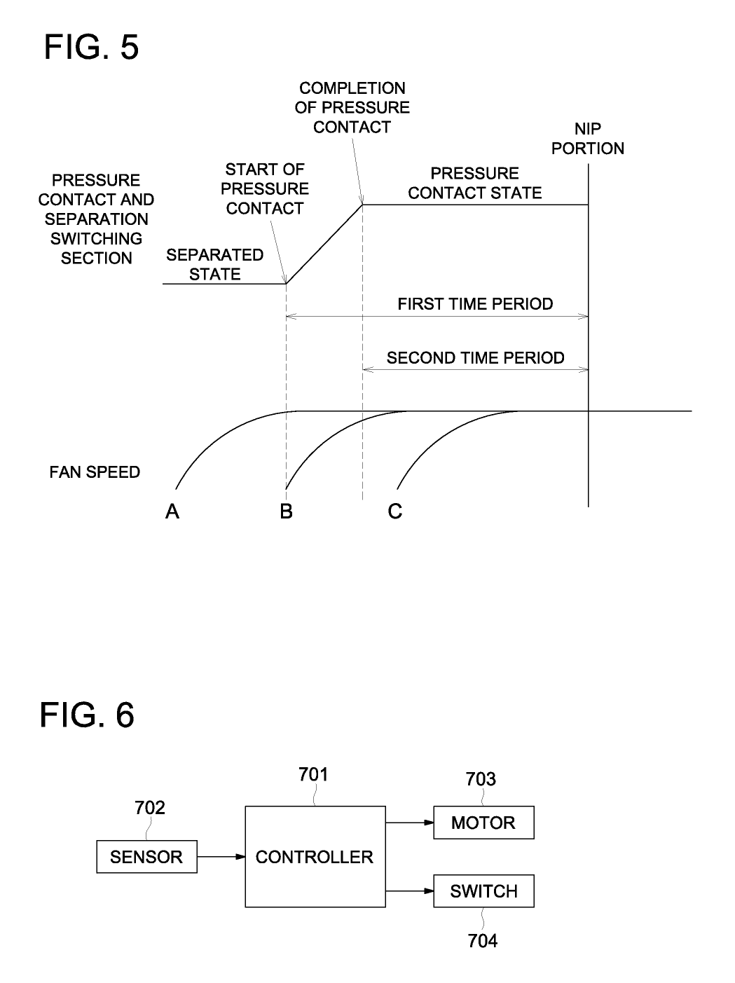

Next, a block diagram for controlling as stated above will be explained as follows, referring to FIG. 6.

As shown in FIG. 1, sensor 702 composed of a photo-sensor that is for detecting sheet feeding is arranged at the upstream side of registration roller 23, and the sensor 702 detects that a recording sheet has been fed. When a prescribed period of time has elapsed after the sensor 702 has detected feeding of the recording sheet, controller 701 composed of CPU and others causes motor 703 that drives the pressure contact and separation switching section 110 to switch from the state of separation to the state of pressure contact. Incidentally, for this switching, it is desirable that the rotation of the fan is started at the moment before 3 seconds or more from the point of time when the leading edge of the recording sheet arrives at the nip portion, if the fan takes 2 seconds to arrive at its highest speed and switching from the state of separation to the state of pressure control takes 1 second. After that, the controller 701 turns on switch 704 connected to the fan to start rotation of the fan to conduct an air blast to the nip portion. Incidentally, it is desirable that the switch 704 is turned on at the moment that is earlier than the point in time for the leading edge of the recording sheet to arrive at the nip portion by 2 seconds or more.

Further, after a series of jobs are terminated, the controller 701 causes motor 703 to operate to switch from the state of pressure contact to the state of separation, and it turns off switch 704 simultaneously.

Though the fixing device explained above is a belt-type fixing device, the invention is not limited to the belt-type fixing device, and it can be applied also to the fixing device of other type such as a heating roller fixing device.

In the case of the fixing device of the embodiment and in the case of the image forming apparatus equipped with the aforesaid fixing device, an air blasting device to blow air to separate a recording sheet and the pressure contact and separation switching section to move a pressure roller are provided, to control so that air blast by the air blasting device may not be conducted when the pressure contact and separation switching section is in the state of separation. Due to this, it is possible to prevent that members such as an intermediate transfer belt positioned at the upstream side of the fixing device and a transfer device are hit by high temperature air, and toner is melted and image failures are caused.

What is claimed is:

1. A fixing device in which a toner image on a recording material is fixed at a nip portion that is formed by a heated fixing member and by a pressure member that applies pressure to the heated fixing member, the fixing device comprises:
(a) an air blower having a fan which blows air that is sent by a rotation of the fan, on a neighborhood of an exit of the nip portion;
(b) a pressure contact and separation switching section capable of switching between a pressure contact state in which the pressure contact and separation switching section causes the pressure member to move and to be in pressure contact with the fixing member and a separated state in which the pressure contact and separation switching section causes the pressure member to move and to be separated from the fixing member, wherein pressure contact and separation switching section switches from the separated state to the pressure contact state at a moment that is earlier by a predetermined period of time than a point in time when a leading edge of the recording material arrives at the nip portion; and
(c) a controller that controls so that the fan starts rotation thereof within a first time period between a point in time when the pressure contact and separation switching section starts a changeover from the separated state to the pressure contact state and a point in time when the leading edge of the recording material arrives at the nip portion.

2. The fixing device of claim 1, wherein the controller starts the rotation of the fan so that the rotation of the fan reaches a maximum speed in the first time period.

3. The fixing device of claim 1, wherein the controller starts the rotation of the fan so that the rotation of the fan reaches a maximum speed in a second time period between a point in time when the pressure contact and separation switching section finishes the changeover from the separated state to the pressure contact state and a point in time when the leading edge of the recording material arrives at the nip portion.

4. An image forming apparatus comprising the fixing device of claim 1.

5. A fixing method in which a toner image on a recording material is fixed at a nip portion that is formed by a heated fixing member and by a pressure member that applies pressure to the heated fixing member, the fixing method comprising:
(a) blowing air sent by a rotation of a fan in an air blower, on a neighborhood of an exit of the nip portion;
(b) switching between a pressure contact state in which the pressure member is moved and is in pressure contact with the fixing member and a separated state in which the pressure member is moved and is separated from the fixing member, wherein the switching step includes switching from the separated state to the pressure contact state at a moment that is earlier by a predetermined period of time than a point in time when a leading edge of the recording material arrives at the nip portion; and
(c) controlling the fan to start rotation thereof within a first time period between a point in time when a changeover is started from the separated state to the pressure contact state and a point in time when the leading edge of the recording material arrives at the nip portion.

6. The fixing method of claim 5, wherein the controlling step includes controlling the fan to start the rotation so that the rotation of the fan reaches a maximum speed in the first time period.

7. The fixing method of claim 5, wherein the controlling step includes controlling the fan to start the rotation so that the rotation of the fan reaches a maximum speed in a second time period between a point in time when the changeover from the separated state to the pressure contact state is finished and a point in time when the leading edge of the recording material arrives at the nip portion.
